(19) United States
(12) Patent Application Publication
(10) Pub. No.: US 2008/0011131 A1
(43) Pub. Date: Jan. 17, 2008

(54) Power Driving Assembly for a Disc Brake Being Resurfaced

(76) Inventor: Anders Borring, Odense (DK)

Correspondence Address: FOLEY AND LARDNER LLP;SUITE 500, 3000 K STREET NW, WASHINGTON, DC, 20007, US

(21) Appl. No.: 11/574,795

(22) PCT Filed: Sep. 6, 2005
(86) PCT No.: PCT/IB05/52897

§ 371 Date: Aug. 31, 2007

(30) Foreign Application Priority Data
Sep. 7, 2004 (DK) BA 2004 00232

(51) Int. Cl. B23B 5/04

(52) U.S. Cl. 82/112

(57) ABSTRACT

A power driving assembly (17) serves for rotating a disc brake (2) being resurfaced by means of a disc brake lathe (1) mounted onto the caliper mounting brackets (3) of a vehicle wheel hub assembly (4). The power driving assembly (17) comprises a motor (18) and a shaft (19) for transmitting the power from the motor (18) to the disc brake (2). The shaft is a flexible shaft (19), which is connected to a gear (15) of a gearbox (15′), which again is connected to the disc brake (2). The motor (18) and the disc brake (2) can be correctly connected to each other quickly and easily.

### FIELD OF THE INVENTION

The invention relates to a power driving assembly for rotating a disc brake being resurfaced by means of a disc brake lathe mounted onto e.g. the caliper mounting brackets of a vehicle wheel hub assembly, and also to a method for using said power driving assembly.

The power driving assembly comprises more specifically a motor and a shaft for transmitting the power from the motor to the disc brake.

### BACKGROUND ART

The disc brakes of a vehicle are subject to wearing when driving the vehicle. When the disc brakes are worn-out, they need to be resurfaced.

To perform this process the disc brakes originally were removed from the vehicle and resurfaced by means of an independent brake lathe. This process was, however, time-consuming and difficult to carry out.

In order to remedy said drawbacks of the earlier technique portable disc brake lathes were developed for resurfacing a disc brake without removing this from the vehicle.

Such portable disc brake lathe is e.g. known from the U.S. Pat. No. 4,854,199.

This disc brake lathe is during operation mounted onto the caliper mounting brackets of the vehicle wheel hub assembly after removing the wheel and the caliber.

Said known disc brake lathe comprises a frame with two jaws for securing the frame to the caliper mounting brackets. The jaws are arranged on two opposed arms, which are vertically slidingly mounted on the frame in such way that the arms always are maintained in symmetrical positions in relating to the caliper mounting brackets upon which the disc brake lathe is mounted.

The jaws can be adjusted to fit the existing different caliper mounting brackets owing to the fact that the arms are slidingly mounted on the frame.

Two opposite tool bits for resurfacing both sides of the disc brake are moreover mounted on a carriage mounted slidingly on the frame in longitudinal direction.

Since the arms with the jaws always are maintained in symmetrical positions in relation to different caliper mounting brackets, the tool bits will always be conveyed along the same rectilinear line without regard to the type of the caliper mounting brackets in question thereby advantageously obtaining that the resurfacing of different disc brakes always is optimally performed.

The portable disc brake lathe known from the above mentioned U.S. Pat. No. 4,854,199 has however a complicated and costly construction and is moreover difficult to mount upon the caliper mounting brackets.

When resurfacing a disc brake by means of a portable disc brake lathe the disc brake is rotated by means of a power driving assembly, which comprises a motor and a shaft for transmitting the power from the motor to the disc brake.

A power driving assembly of that kind is known from the U.S. Pat. No. 5,549,023.

When resurfacing the disc brake of a vehicle, this vehicle is normally lifted into a comfortable working position over the floor of the garage where the resurfacing process takes place, as e.g. seen in FIG. 1 of said US patent.

The motor of the power driving assembly is situated in the same or about the same level as the disk brake to be resurfaced by means of a post on a tripod with wheels, which can be locked during operating.

The power for rotating the disc brake is transmitted from the motor to the disc brake by means of a mainly horizontal shaft.

The above-described arrangement of the power driving assembly known from the U.S. Pat. No. 5,549,023 implies however the serious problem that it is a very time-consuming and also difficult to adjust the power driving assembly and the disc brake to be resurfaced into such mutual operation positions that the resurfacing of the disc brake can be carried out effectively and unproblematic and the required quality of the finished disc brake surfaces be obtained.

Another serious problem consists in that said known power driving assembly is dangerous to use since the motor and the shaft for rotating the disc brake is situated in the operational area for the operator which therefore run the risk of being injured because the clothes of the operator could be caught by the rotating shaft and/or the engagement of this with the disc brake.

The construction of the known power driving assembly is moreover highly unstable with the result that the quality of the surfaces of the resurfaced disc brake can be unsatisfactory even if the resurfacing operation takes place with the power driving assembly and the disc brake adjusted into optimal mutual operation positions.

The above-mentioned disadvantages of the prior art means for resurfacing a disc brake of a vehicle are, is according to the present invention, remedied by,

in a first aspect of the invention providing a power driving assembly of the kind mentioned in the opening paragraph which is able to be brought into correct operation position in relation to the disc brake to be resurfaced quickly and easily,

in a second aspect of the invention providing a power driving assembly of the kind mentioned in the opening paragraph which has a stable construction,

in a third aspect of the invention providing a power driving assembly of the kind mentioned in the opening paragraph which is more safe to operate than hitherto known, and

in a fourth aspect of the invention providing a power driving assembly of the kind mentioned in the opening paragraph which has a simple and inexpensive construction.

### SUMMARY OF THE INVENTION

Resurfacing of a disc brake of a vehicle without removing the disc brake takes place by means of a disc brake lathe mounted onto e.g. the caliper mounting brackets of the vehicle wheel hub assembly after removing the wheel and the caliber.

The disc brake is during the resurfacing process rotated by means of a power driving assembly comprising a motor and a shaft for transmitting the power from the motor to the disc brake.

The novel and unique features of the invention consist in the fact that the power driving assembly comprises that the transmitting shaft is a flexible shaft, which is connected to a gear of a gearbox, which again is connected to the disc brake.

The flexible shaft implies advantageously that the motor and the disc brake immediately and without any time-consuming and difficult adjusting process can be power-connected into mutual operation positions where the resurfacing process duly can be carried out with such result that the required quality of the finished disc brake surfaces is obtained.

Another advantageous consist in that the power driving assembly according to the invention is safe to use for the operator since the real flexible shaft is placed in a hose and the gearbox is functioning as a guard for the disc brake thereby obtaining that the clothes of the operator cannot be caught by any rotating parts relating to the power driving assembly during operation.

The motor is preferably a fast-running motor rotating the flexible shaft with the high velocity of rotation required for making a flexible shaft capable of effectively transmitting the power from the motor to the disc brake.

The gear serves for reducing said high velocity of rotation of the flexible shaft to the lower velocity of rotation of the disc brake, with which the resurfacing process is carried out.

The motor can according to the invention furthermore be a gear motor with the velocity of rotation of the output shaft adjusted to the optimum velocity of rotation of the flexible shaft.

A carrier can according to the invention be connected to the automotive wheel hub assembly for reliably and effectively coupling the gear with the disc brake.

The carrier is, in an advantageously embodiment, formed with a hexagonal stud which fits into a corresponding aperture in the gear, whereby the rotation axis of the gear can be brought into alignment with the rotation axis of the disc brake quickly and correctly.

The hexagonal shape of the stud serves for transmitting the torque between the gear and the disc brake.

The torque can in other embodiments be transmitted by means of studs and apertures having other cross sections, par example triangular cross sections, or by means of key and slot arrangements.

The gear can according to the invention in a simple and inexpensive embodiment be a mechanical gear.

The flexible shaft can furthermore have a sufficient length to allow the disc brake to be lifted to a relatively high level while the motor is placed at a relatively low level, thereby being able to resurface the disc brake in a comfortable operation level while the relatively heavy motor advantageously is placed relatively close to the floor of the respective garage.

The motor can according to the invention be placed upon a support on the floor of the garage where the resurfacing process takes place.

The gear can be mounted in a gearbox, which according to the invention is retained against being rotated.

The retaining of the gearbox can in an expedient embodiment according to the invention be carried out by means of brackets extending between the gearbox and the disc brake lathe mounted e.g. onto the caliper mounting brackets.

### BRIEF DESCRIPTION OF THE DRAWING

The object, features and advantages of the invention will in the following be explained in more details with reference to the drawing in which,

FIG. 1 shows schematically in perspective a disc brake lathe in position for resurfacing a disc brake,

FIG. 2 shows schematically the same in perspective but with the disc brake connected to a gear of a power driving assembly according to the invention for rotating the disc brake seen in FIG. 1, and

FIG. 3 shows schematically in perspective the power driving assembly rotary connected to the disc brake being resurfaced by means of the disc brake lathe seen in FIG. 1.

### DETAILED DESCRIPTION OF THE INVENTION

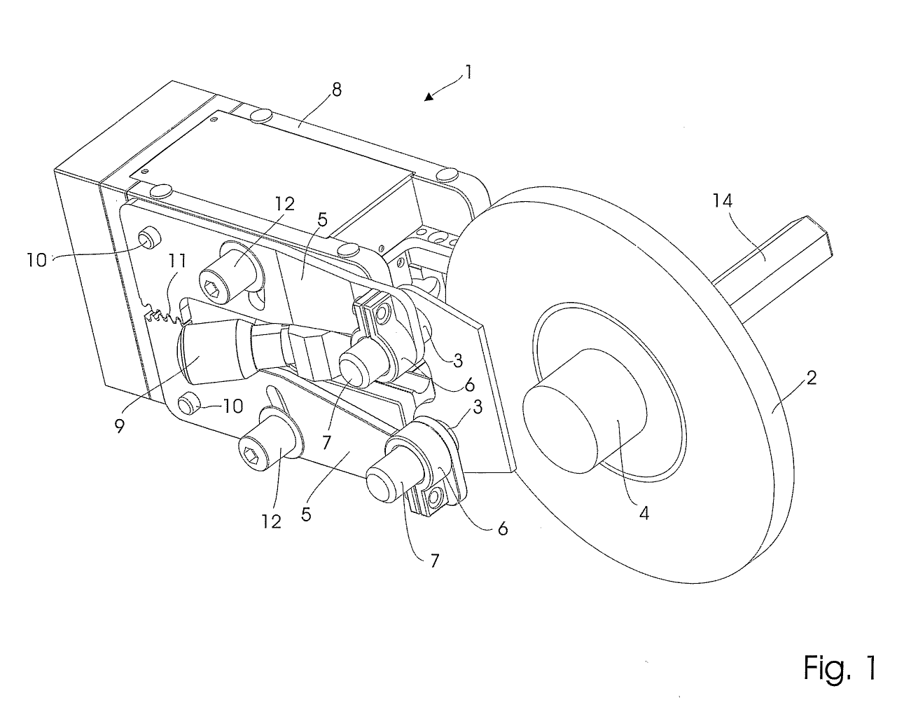

A schematically shown disc brake lathe 1 is, after removing the wheel and the caliper of a vehicle (not shown), in FIG. 1 in position for resurfacing a disc brake 2.

The disc brake lathe 1 is mounted onto the caliper mounting brackets 3 of the wheel hub assembly 4 of the vehicle by means of adapter arms 5 having, in this case, split bushings 6 placed on adapters 7 mounted into the holes in the caliper mounting brackets for mounting the now removed caliper.

The resurfacing of the disc brake takes place by means of cutting tips (not shown) on a slide in the disc brake lathe head 8. The cutting depth is set by means of micrometers 9.

The distance between the adapter holes in the caliper mounting brackets can be varied in dependence of the make of vehicle. The adapter arms are therefore pivotally mounted on pivots 10 on the disc brake lathe head whereby the distance between the split bushings of the adapter arms easily can be adjusted to the distance between the adapter holes in the caliper mounting brackets of the vehicle in question.

Toothed segments 11 on the adapter arms serve for maintaining said arms in symmetrical positions about a center line irrespective of the distance between the adapter holes in the caliper mounting brackets in question thereby advantageously ensuring that the cutting tips always are machining the surfaces of disc brakes along the same predetermined line.

The positions of the adapter arms are secured by means of fixing nuts 12.

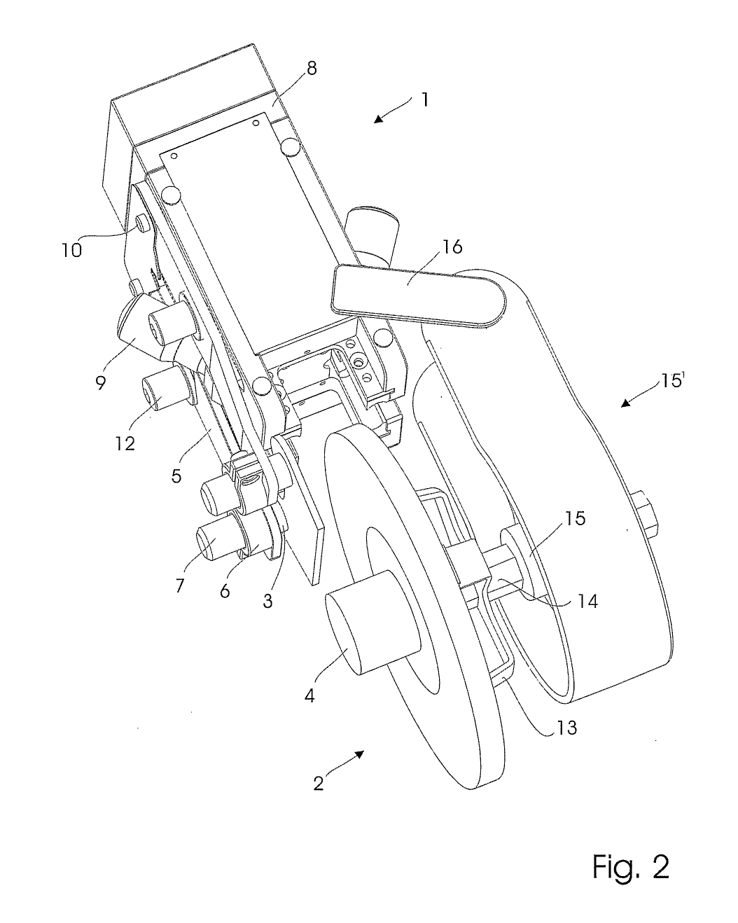

FIG. 2 shows schematically in perspective the disc brake lathe 1 and the disc brake 2 and also a gear 15 connected to the disc brake.

A carrier 13 is, as seen, mounted on the disc brake 2. The carrier is equipped with a stud 14 fitting into a corresponding aperture in the gear 15. The stud and the cor-responding aperture have in this case a hexagonal shape for making it possible to transmit a torque from the gear to the disc brake.

The gear 15 is placed in a gearbox 15′ which is retained against being rotated by means of brackets 16 pivotally arranged on the gearbox for being attached to the disc brake lathe head 8 when the gear is connected to the carrier 13 on the disc brake 2.

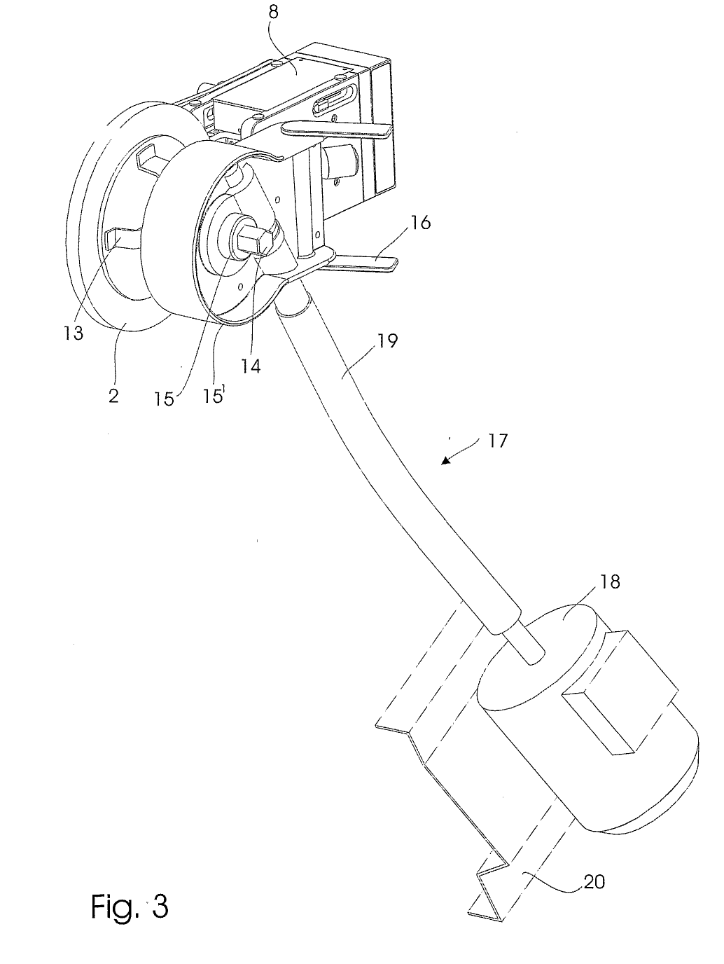

FIG. 3 shows that the gear 15 is part of a power driving assembly 17 for rotating the disc brake during the resurfacing process. The pivotal brackets 16 have, in the situation shown, not yet been attached to the disc brake lathe head 8.

The power driving assembly comprises a motor 18, which is connected to the gear 15 by means of a flexible shaft 19.

The motor is mounted on a support 20, which is placed on the floor (not shown) of e.g. the garage (not shown) where the resurfacing process takes place.

When a disc brake is to be resurfaced the wheel (not shown) and the caliber (not shown) are first removed. Then the disc brake lathe 1 is mounted on the caliper mounting brackets 3, after which the carrier 13 is mounted onto the disc brake 2 and the gear 15 is mounted onto the hexagonal stud 14 of the carrier 13. Then the resurfacing process is carried out in a way known per se.

The flexible shaft implies advantageously that the motor and the disc brake, immediately and without any time-consuming and difficult adjusting process, can be power-connected into mutual operation positions where the resurfacing process duly can be carried out and the desired high quality of the finished disc brake surfaces be obtained.

The motor 18 is preferably a fast-running motor and the flexible shaft 19 is adapted to rotate with the high velocity of the motor. The gear 15 then serves for reducing said high rotation velocity to the lower rotation velocity required for machining the surfaces of the disc brake.

The motor 18 and the disc brake 2 are, owing to the arrangement of the power driving assembly 17, able to be connected correctly to each other quickly and easily.

The arrangement of the power driving assembly 17 also makes it possible to resurface the disc brake 2 at a comfortable high operation level and simultaneously to safely place the motor 18 at a low position upon or close to the floor of the respective garage.

The construction of the power driving assembly moreover is arranged in such way that the operator doesn't run any risk for being injured by operating the power driving assembly.

The disc brake lathe can within the scope of the invention, instead of being mounted upon the caliper mounting brackets of the vehicle wheel hub assembly, be mounted onto other parts of this.

1-10. (canceled)

11. A power driving assembly for rotating a disc brake being resurfaced by means of a disc brake lathe mounted onto e.g. caliper mounting brackets of a vehicle wheel hub assembly, comprising a motor and a shaft for transmitting the power from the motor to the disc brake, wherein the power driving assembly comprises that the transmitting shaft is a flexible shaft which is connected to a gear of a gearbox which again is connected to the disc brake.

12. A power driving assembly according to claim 11, wherein the gearbox is connected to the disc brake via a carrier connected to the vehicle wheel hub assembly.

13. A power driving assembly according to claim 12, wherein the carrier is formed with a hexagonal stud fitting into a corresponding aperture in the gear.

14. A power driving assembly according to claim 12, wherein the flexible shaft has a length sufficiently long enough to allow the motor to be placed on another level than the disc brake being resurfaced.

15. A power driving assembly according to claim 11 wherein the motor is mounted on a support.

16. A power driving assembly according to claim 11 wherein the power driving assembly comprises means adapted to retain the gearbox against being rotated.

17. A power driving assembly according to claim 16, wherein the retaining means are brackets pivotally mounted on the gearbox and engaging the disc brake lathe mounted on the caliper mounting brackets.

18. A power driving assembly according to claim 11 wherein the gear of the gearbox is a mechanical gear.

19. A power driving assembly according to claim 11 wherein the motor is a gear motor.

20. A method for using the power driving assembly according to claim 11 for rotating a disc brake being resurfaced by means of a disc brake lathe mounted onto caliper mounting brackets of a vehicle wheel hub assembly.

21. A power driving assembly according to claim 13, wherein the flexible shaft has a length sufficiently long enough to allow the motor to be placed on another level than the disc brake being resurfaced.
